(19) United States
(12) Patent Application Publication
(10) Pub. No.: US 2024/0364252 A1
(43) Pub. Date: Oct. 31, 2024

(54) CONTROL APPARATUS FOR ELECTRIC MOTOR

(71) Applicant: ISUZU MOTORS LIMITED, Yokohama-shi (JP)

(72) Inventors: Futoshi YAMANE, Fujisawa-shi (JP); Takuya KIKUCHI, Fujisawa-shi (JP)

(21) Appl. No.: 18/645,638

(22) Filed: Apr. 25, 2024

(30) Foreign Application Priority Data
Apr. 27, 2023 (JP) 2023-073531

(51) Int. Cl. H02P 29/64; H02P 21/20; H02P 21/22; H02P 25/022

(52) U.S. Cl. CPC H02P 29/64; H02P 21/20; H02P 21/22; H02P 25/022

(57) ABSTRACT

A control apparatus for an electric motor that can improve ride comfort and operation stability is provided. The control apparatus includes: a rotor provided with one of a permanent magnet and a winding; and a stator provided with the other of the permanent magnet and the winding. The control apparatus includes a control part. When a temperature of the winding is lower than a predetermined temperature at activation of the electric motor, the control part controls a d-axis current to increase the temperature of the winding. When a rotation torque due to the d-axis current is generated at the rotor, the control part controls a q-axis current such that a rotation torque with the same magnitude as that of the rotation torque due to the d-axis current in a direction opposite to a direction of the rotation torque due to the d-axis current is generated at the rotor.

### CROSS REFERENCE TO RELATED APPLICATIONS

This application is entitled to (or claims) the benefit of Japanese Patent Application No. 2023-073531 filed on Apr. 27, 2023, the disclosure of which including the specification, drawings and abstract is incorporated herein by reference in its entirety.

### TECHNICAL FIELD

The present disclosure relates to a control apparatus for an electric motor.

### BACKGROUND ART

Electric vehicles (EVs) use electric motors as the power source for travelling. The electric motor includes a rotor provided with one of a permanent magnet and a winding, and a stator provided with the other of the permanent magnet and the winding. Such an electric motor cannot be activated when the winding temperature is smaller than a predetermined temperature. In view of this, a current is supplied to the d-axis to increase the winding temperature to the temperature that allows for activation.

For example, Japanese Patent Application Laid-Open No. 2021-141747 discloses that a command value of a d-axis current is changed to increase the temperature of the motor.

### CITATION LIST

### Patent Literature

### PTL 1

Japanese Patent Application Laid-Open No. 2021-141747

### SUMMARY OF INVENTION

### Technical Problem

Incidentally, in an electric motor, when a d-axis current flows in the state where the N pole generated at the winding and the S pole of the permanent magnet do not face each other, the rotor rotates such that the N pole and the S pole face each other, for example. As a result, the stationary vehicle rapidly moves in response to the rotation of the stationary vehicle, which has a significant impact on ride comfort and operation stability.

An object of the present disclosure is to provide a control apparatus for an electric motor that can improve ride comfort and operation stability.

### Solution to Problem

To achieve the above-mentioned object, a control apparatus for an electric motor in the present disclosure includes: a rotor provided with one of a permanent magnet and a winding; and a stator provided with the other of the permanent magnet and the winding. The control apparatus includes a control part. When a temperature of the winding is lower than a predetermined temperature at activation of the electric motor, the control part controls a d-axis current to increase the temperature of the winding. When a rotation torque due to the d-axis current is generated at the rotor, the control part controls a q-axis current such that a rotation torque with the same magnitude as that of the rotation torque due to the d-axis current in a direction opposite to a direction of the rotation torque due to the d-axis current is generated at the rotor.

### Advantageous Effects of Invention

According to the present disclosure, ride comfort and operation stability can be improved.

### BRIEF DESCRIPTION OF DRAWINGS

FIG. 1 is a sectional view of an IPM (Interior Permanent Magnet) motor in an embodiment of the present disclosure;

FIG. 2 is a diagram illustrating an equivalent model of the IPM motor in the embodiment of the present disclosure;

FIG. 3 is a conceptual diagram of a motor in which the 3-phase (u, v, w) coordinate system illustrated in FIG. 2 is represented by a two-phase (d, q) coordinate system of direct current;

FIG. 4 is a functional block diagram illustrating an example of a control apparatus for the IPM motor in the embodiment of the present disclosure; and

FIG. 5 is a flowchart illustrating an example of an operation of a control apparatus for the IPM motor in the embodiment of the present disclosure.

### DESCRIPTION OF EMBODIMENTS

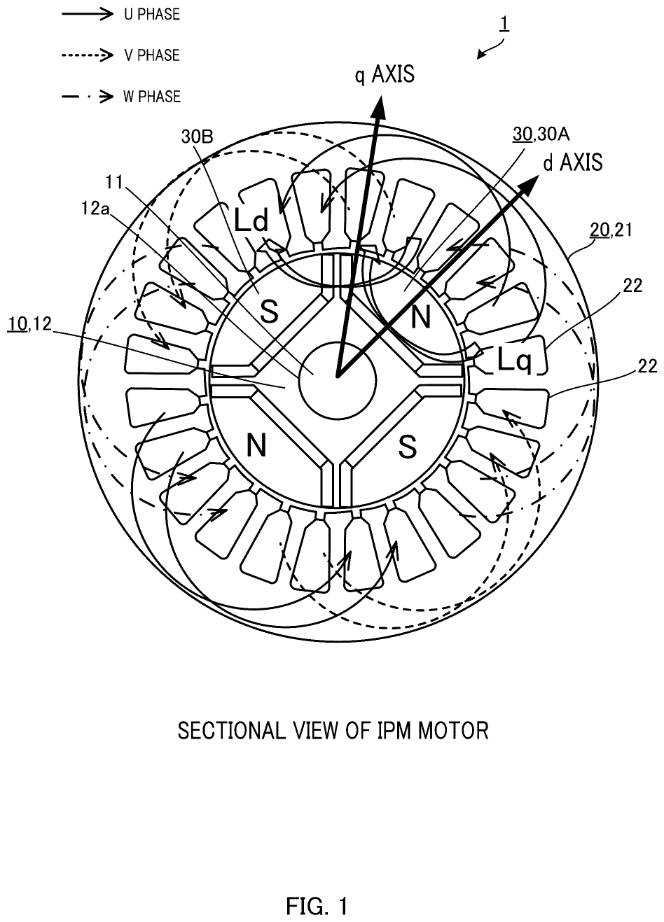

An embodiment of the present disclosure is described below with reference to the drawings. FIG. 1 is a sectional view of an IPM motor in an embodiment of the present disclosure. IPM motor 1 is an inner rotor type motor that includes rotor 10 and stator 20, in which rotor 10 is disposed inside stator 20. IPM motor 1 includes four poles.

### Rotor 10

Rotor 10 includes shaft 11 and rotor core 12.

Shaft 11 includes a columnar shaped member, and extends in the depth direction in FIG. 1.

Rotor core 12 includes a cylindrical member, and includes shaft hole 12a along the axis line direction (depth direction). Shaft 11 is fit to shaft hole 12a. In this manner, rotor core 12 rotates together with shaft 11 around the axis.

### Permanent Magnet 30

In the present embodiment, rotor 10 includes four permanent magnets 30 with the same shape. Four permanent magnets 30 are disposed such that the paired permanent magnets 30 are at an equal angular interval with respect to the axis line. Permanent magnets 30 are all arranged in radially opposed positions, and N pole magnet 30A with N pole and S pole magnet 30B with S pole are alternately disposed around the axis line.

### Stator 20

Stator 20 includes cylindrical stator core 21. Stator core 21 is disposed to surround the outer periphery of rotor 10.

A plurality of (here, 24) windings 22 (coils) is disposed on the inner periphery side of stator core 21. The plurality of windings 22 is disposed at an equal angular interval with respect to the axis line of rotor 10. When a 3-phase AC voltage of U phase, V phase and W phase is applied from the inverter circuit (not illustrated in the drawing) to the plurality of windings 22, a magnetic field is generated inside stator core 21.

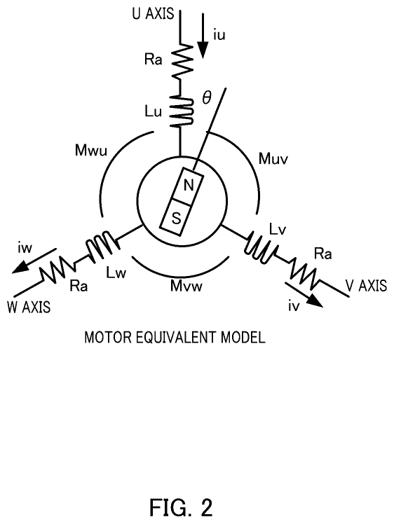

FIG. 2 is a diagram illustrating an equivalent model of the IPM motor in the embodiment of the present disclosure. FIG. 2 illustrates a model based on a 3-phase (U phase, V phase, W phase) winding. In FIG. 2, iu is the u-phase armature current, iv is the v-phase armature current, iw is the w-phase armature current, θ is the angle of advance of permanent magnet 30 (rotor) from the U phase, and Ra is the armature resistance of each phase. Muv is the mutual inductance between the u phase and v phase, Mvw is the mutual inductance between the v phase and w phase, Mwu is the mutual inductance between the w phase and u phase, Lu is the u-phase self-inductance, Lv is the v-phase self-inductance, and Lw is the w-phase self-inductance.

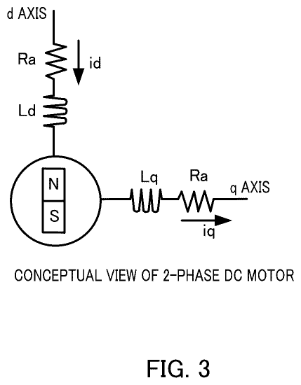

In a model based on the 3-phase winding, a 3-phase voltage can be changed to an αβ coordinate system voltage. Further, by converting the αβ-axis to a dq-axis of a rotation coordinate system as viewed from stator 20, the magnetic flux direction of permanent magnet 30 of rotor 10 and the direction orthogonal to that direction can be set to the d-axis and q-axis, respectively. FIG. 3 is a conceptual diagram of a motor in which the 3-phase coordinate system illustrated in FIG. 2 is represented by a two-phase (d, q) coordinate system of direct current. In FIG. 3, id is the d-axis armature current, iq is the q-axis armature current, Ra is the resistance of each phase armature, Ld is the d-axis self-inductance, and Lq is the q-axis self-inductance. Note that in the two-phase coordinate system illustrated in FIG. 3, the d-axis is set in the magnetic flux (N pole) direction of the permanent magnet of rotor 10, and the q-axis is set to the direction 90 degrees advanced from the d-axis in the forward direction.

Basic torque T of IPM motor 1 is represented by Equation 1.

$$T = Pn \{ Ke - ( Lq - Ld ) id \} iq \qquad ( Equation 1 )$$

Where Pn is the pole-logarithm, Ke is the induced emf constant, Lq is the q-axis inductance, Ld is the d-axis inductance, id is the d-axis current, and iq is the q-axis current.

Note that if the winding temperature is smaller than a predetermined temperature at the activation of IPM motor 1, the activation cannot be performed. In view of this, the winding temperature is increased to the temperature that allows for activation by supplying a current to the d-axis. Incidentally, in IPM motor 1, for example, when a d-axis current flows in the state where the N pole generated at winding 22 and the S pole (S pole magnet 30B) of permanent magnet 30 do not face each other, a rotation torque is generated at rotor 10 such that the N pole and the S pole face each other. As a result, the stationary vehicle rapidly moves in response to the rotation of rotor 10, which has a significant impact on ride comfort and operation stability.

In the present embodiment, the q-axis current is controlled so as to generate at rotor 10 a rotation torque with the same magnitude as that of the rotation torque due to the d-axis current in the direction opposite to the direction of the rotation torque due to the d-axis current, such that the stationary vehicle does not move even when the rotation torque due to the d-axis current is generated at rotor 10.

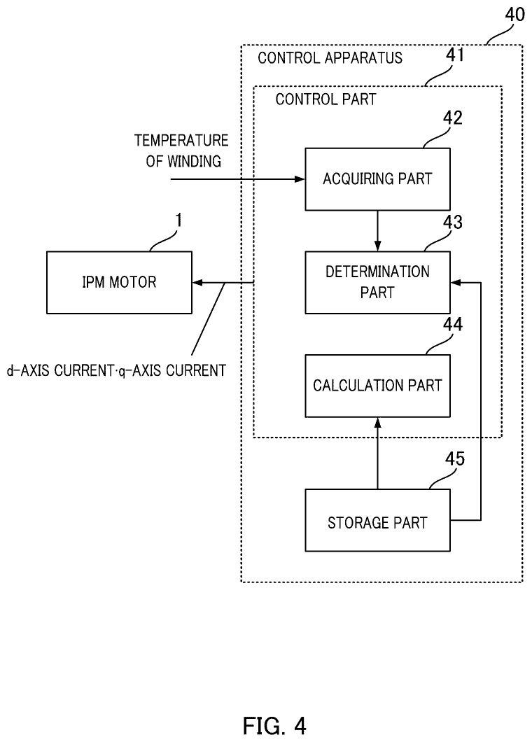

FIG. 4 is a functional block diagram illustrating an example of a control apparatus for the IPM motor in the embodiment of the present disclosure. Control apparatus 40 includes control part 41 and storage part 45. In FIG. 4, the arrow represents the flow of main data, and other data flow not illustrated in FIG. 4 may also be provided. In FIG. 4, each function block represents a configuration in function unit, not a configuration in hardware (apparatus) unit. Therefore, the function block illustrated in FIG. 4 may be mounted in a single apparatus, or may be separately mounted in a plurality of apparatuses. Data may be exchanged between the function blocks through any means such as a data bus and a controller area network (CAN bus).

Storage part 45 is a storage apparatus such as a ROM (Read Only Memory) that stores a BIOS (Basic Input Output System) and the like of a computer that implements control apparatus 40, a RAM (Random Access Memory) that serves as a work area of control apparatus 40, an HDD (Hard Disk Drive) or an SSD (Solid State Drive) that stores the OS (Operating System), application programs, and various information to be referred for execution of the application program, and the like.

In addition, storage part 45 stores a predetermined temperature. The predetermined temperature is set by experiments and/or simulations based on the performance, configuration and the like of IPM motor 1. In the present embodiment, the predetermined temperature is the lower limit value of the temperature range where IPM motor 1 is operative. Note that since detection errors occur depending on the detection accuracy of the temperature sensor, and as such the predetermined temperature may include a predetermined temperature range.

Control part 41 is a processor of the CPU (Central Processing Unit), the GPU (Graphics Processing Unit) and the like of control apparatus 40, and serves as acquiring part 42, determination part 43 and calculation part 44 by executing the program stored in storage part 45.

Note that an exemplary case in which control apparatus 40 illustrated in FIG. 4 is composed of a single apparatus is described here. However, control apparatus 40 may be implemented by a plurality of calculation resources such as processors and memories, for example. In this case, each part making up control part 41 is implemented when at least any of a plurality of different processors executes a program.

Acquiring part 42 acquires the temperature of winding 22 from a temperature detection part (not illustrated in the drawing).

Determination part 43 determines whether the temperature of winding 22 is lower than a predetermined temperature.

Control part 41 controls the d-axis current so as to increase the temperature of winding 22 when the temperature of winding 22 is lower than a predetermined temperature at the activation of IPM motor 1, and, when the rotation torque due to the d-axis current is generated at rotor 10, control part 41 controls the q-axis current such that a rotation torque with the same magnitude as that of the rotation torque due to the d-axis current in the direction opposite to the direction of the rotation torque due to the d-axis current is generated at rotor 10.

Calculation part 44 calculates the current value of the q-axis current such that a rotation torque with the same magnitude as that of the rotation torque due to the d-axis current in the direction opposite to the direction of the rotation torque due to the d-axis current is generated at rotor 10.

Calculation part 44 calculates the current value of the q-axis current on the basis of Equation 2 that represents mutual relationships of the d-axis current, q-axis current and rotation torque. Note that Equation 2 can be derived from the above-mentioned Equation 1.

$$T = Pn * Ψ a * iq + Pn ( Lq - Ld ) id * iq \qquad ( Equation 2 )$$

Where T is the rotation torque, Pn is the pole-logarithm, Ψa is the flux linkage, Lq is the q-axis inductance, Ld is the d-axis inductance, id is the d-axis current, and iq is the q-axis current. Note that the current value of the d-axis current may be a current value corresponding to the temperature of winding 22, or may be a preliminarily set current value regardless of the temperature of winding 22.

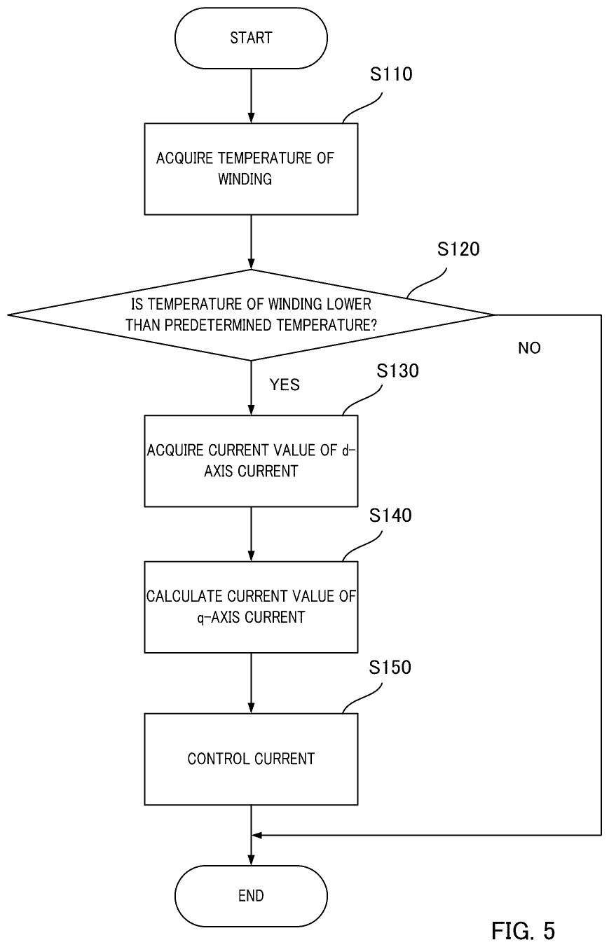

Next, an example of the operation of the control apparatus for the IPM motor in the embodiment of the present disclosure is described. FIG. 5 is a flowchart illustrating an example of the operation of the control apparatus for the IPM motor in the embodiment of the present disclosure. This flow is started at the activation of IPM motor 1.

First, at step S110, acquiring part 42 acquires the temperature of winding 22.

Next, at step S120, determination part 43 determines whether the temperature of winding 22 is lower than a predetermined temperature. When the temperature of winding 22 is lower than a predetermined temperature (step S120:YES), the process is advanced to step S130. When the temperature of winding 22 is equal to or higher than the predetermined temperature (step S120: NO), this flow is terminated.

At step S130, calculation part 44 acquires the current value of the d-axis current.

Next, at step S140, calculation part 44 calculates the current value of the q-axis current with reference to Equation 2 on the basis of the current value of the d-axis current.

Next, at step S150, control part 41 controls IPM motor 1 on the basis of the current value of the d-axis current and the current value of the q-axis current.

Control apparatus 40 of IPM motor 1 in the present embodiment is a control apparatus for an electric motor including rotor 10 provided with one of permanent magnet 30 and winding 22 and stator 20 provided with the other of permanent magnet 30 and winding 22, and includes control part 41. Control part 41 controls the d-axis current so as to increase the temperature of winding 22 when the temperature of winding 22 is lower than a predetermined temperature at the activation of IPM motor 1. When the rotation torque due to the d-axis current is generated at rotor 10, control part 41 controls the q-axis current such that a rotation torque with the same magnitude as that of the rotation torque due to the d-axis current in the direction opposite to the direction of the rotation torque due to the d-axis current is generated at rotor 10.

With the above-mentioned configuration, by supplying the d-axis current to winding 22, the temperature of winding 22 is increased, and IPM motor 1 can be activated. In addition, by supplying the q-axis current to winding 22, the rotation torque due to the d-axis current and the rotation torque due to the q-axis current are canceled, and the rotation torque is not generated at rotor 10. Thus, the stationary vehicle does not rapidly move in response to the rotation of the stationary vehicle, and ride comfort and operation stability can be improved.

In addition, control apparatus 40 of IPM motor 1 of the present embodiment further includes calculation part 44 that calculates the current value of the q-axis current on the basis of the equation that represents mutual relationships of the d-axis current, q-axis current and rotation torque. In this manner, the rotation torque due to the d-axis current and the rotation torque due to the q-axis current can be reliably canceled.

In addition, in control apparatus 40 of IPM motor 1 of the present embodiment, calculation part 44 calculates the current value of the q-axis current based on the following equation.

$$T = Pn * Ψ a * iq + Pn ( Lq - Ld ) id * iq$$

Where T is the rotation torque, Pn is the pole-logarithm, Ψa is the flux linkage, Lq is the q-axis inductance, Ld is the d-axis inductance, id is the d-axis current, and iq is the q-axis current. With the above-mentioned configuration, calculation part 44 can directly calculate the current value of the q-axis current by substituting the d-axis current (id) into the above-mentioned equation.

The above-mentioned embodiments are merely examples of embodiments for implementing the present disclosure, and the technical scope of the present disclosure should not be interpreted as limited by them. In other words, the present disclosure can be implemented in various forms without deviating from its gist or main features.

The present disclosure is suitable for electric vehicles including a control apparatus for an electric motor that requires improvement in ride comfort and operation stability.

1. A control apparatus for an electric motor, comprising:
a rotor provided with one of a permanent magnet and a winding; and
a stator provided with the other of the permanent magnet and the winding,
wherein the control apparatus includes a control part,
wherein when a temperature of the winding is lower than a predetermined temperature at activation of the electric motor, the control part controls a d-axis current to increase the temperature of the winding, and
wherein when a rotation torque due to the d-axis current is generated at the rotor, the control part controls a q-axis current such that a rotation torque with the same magnitude as that of the rotation torque due to the d-axis current in a direction opposite to a direction of the rotation torque due to the d-axis current is generated at the rotor.

2. The control apparatus for the electric motor according to claim 1, further comprising a calculation part configured to calculate a current value of the q-axis current based on an equation representing a mutual relationship of the d-axis current, the q-axis current and the rotation torque.

3. The control apparatus for the electric motor according to claim 2, wherein the calculation part calculates the current value of the q-axis current based on the following equation:
$$T = Pn * Ψ a * iq + Pn ( Lq - Ld ) id * iq$$
wherein T is a rotation torque, Pn is a pole-logarithm, Ψa is a flux linkage, Lq is a q-axis inductance, Ld is a d-axis inductance, id is a d-axis current, and iq is a q-axis current.

4. The control apparatus for the electric motor according to claim 2, wherein the calculation part calculates the current value of the q-axis current based on a predetermined current value of the d-axis current.
